(19) United States
(12) Patent Application Publication
(10) Pub. No.: US 2011/0252340 A1
(43) Pub. Date: Oct. 13, 2011

(54) System and Method For Virtual Online Dating Services

(76) Inventor: Kenneth Thomas, Houston, TX (US)

(21) Appl. No.: 13/084,493

(22) Filed: Apr. 11, 2011

Related U.S. Application Data
(60) Provisional application No. 61/323,321, filed on Apr. 12, 2010.

(51) Int. Cl. G06F 3/01; G06F 15/16

(52) U.S. Cl. 715/756

(57) ABSTRACT

A system and method for: providing virtual social networking and online dating services; providing collaborative capability between a plurality of members; and providing interactive live multi-point streaming video/audio to the members. The collaborative capability may include auditions. Further, the collaborative capability and interactive live multi-point streaming video/audios may be provided through a single site. The system and method may provide for direct referrals between members and online video dating including speed dating. Further, the social/dating service may also interact with other services.

### CROSS-REFERENCE TO RELATED APPLICATIONS

The present application is related to and claims priority from prior provisional application Ser. No. 61/323,321 filed by Kenneth Thomas on Apr. 12, 2010 and entitled “System and Method For Virtual Online Services”, the contents which are incorporated herein by reference

### BACKGROUND

1. Field of the Invention

The present invention relates generally to virtual and online services and, more specifically, to social networking/online dating services employing live multi-point streaming video/audios to facilitate multiple participants to interact and collaborate. The technology may be used for other purposes as well e.g. business.

2. Description of the Related Art

General online dating services (e.g., Match.com, Yahoo Personals, LavaLife, AmericanSingles, and others) cover the largest part of the online social market by catering to the casual dating interests of the marketplace. Relationship services (e.g., eHarmony, Chemistry.com and PerfectMatch.com) use questionnaires and analytical systems to assess an in-depth user profile for better more serious matches. Social networking sites (e.g., MySpace, Facebook, LinkedIn, Engage.com and others) represent the fastest growing segment. As a result of the increased time consumers are spending in the virtual world of social networking and online dating sites, the demand for more intimate connections and encounters have also increased over the past few years. It is believed that consumers would welcome more than having only a static image (picture) of a person as a visual to communicate with in the virtual world. Such interaction via a static image (picture) is not natural. Furthermore, the static image of the person on the other end in communications (i.e., via email or instant chat) in the virtual world often time does not represent the true appearance and/or personality of that person, especially when it comes to online dating.

Further, existing virtual social networking/dating services often provide inadequate descriptions via member profiles and pictures of members that may not be a true or accurate representation of the appearances and personalities of the members. Furthermore, the aforementioned types of sites are also generally deficient in their interaction capabilities. Indeed, it is believed that online dating services (e.g., eHarmony, Match.com, Yahoo Personals, etc.), virtual social networking sites (e.g., MySpace, Facebook, YouTube. etc.), and so forth, are deficient in the interactive interfaces to accommodate current demands and opportunities. In consideration of what is currently being provided by these services and the ever-increasing demand of consumers for more intimate interaction capabilities in the virtual world, there is a real need for improved user-interactive capabilities and additional technologies for both the virtual social networking and online dating services.

### SUMMARY OF THE INVENTION

One aspect of the disclosure relates to a computer-implemented method for facilitating selection of a dating partner. Using the technology described herein a member of an online dating service selects a plurality of candidate dating partners (e.g., by viewing their profiles and/or a short video). The member then creates a list of the candidate dating partners. After creating the list, the member can perform a more refined selection by forming a panel of online friends who will then join together (via live multi-point streaming video in real-time) to evaluate each of the candidate dating partners. The evaluation can be done interactively by the member (host) along with the panel substantially in real time. During the evaluation, videos and the profile for each of the candidate dating partners can be selected and viewed by the host and the panel who then can provide comments, e.g., using a chat box. Preferably, the host and the panelists can also view each other (e.g., using web cams on each of their computers) on a screen designed for this purpose.

According to other aspects of the present invention, a candidate dating partner can be invited to an online audition. Similar to the selection process outlined above, the online audition can also include a host and a panel. The interviewee may also invite its panel members. In this case, the invitee would also be “present” (e.g., a live video stream using the invitee's web cam). However, the host of the online audition need not be the member who is interested in dating the candidate dating partner. That is, the host of the online audition need not be the same person who was host of the selection process described above. In some embodiments, each panelist on the panel can view the host, the selected candidate partner and the other panelists but the selected candidate dating partner will only be able to view the host unless allowed by the host. Likewise, the host and its panel will only be able to view the interviewee and not its panel unless allowed by the interviewee. This allows for the panelists and the host to provide comments more freely. Preferably, the panel and host can communicate in a chat box hidden from the candidate dating partner. The candidate may also have its own panel members and communicate with its panel via its own chat box, which is hidden from the host and its panel. Both the host and the interviewee has the capability to swap screens with any member of its own panel to allow another person to communicate directly with the other.

According to other aspects of the present invention, a selected candidate dating partner can be invited to a “speed date” with a member. Video (e.g., web cam video) of the selected candidate dating partner and the member (host) can be displayed side by side (or similarly) and a panel can likewise be present. As with the audition, the panelists can be muted with respect to the selected candidate dating partner. Also, a chat box can be provided to the host and the panel but not to the selected candidate partner. In a preferred embodiment, the speed date will end after a predetermined length of time (e.g., 20 minutes) and the amount of time used and left will be displayed. We are not claiming Speed Dating since it is already public domain

According to other aspects of the invention, members can go on “online dates”. In these online dates, the couple can each have live multi-point streaming videos displayed on the screen (e.g., using web cams for each person). Like with the audition and speed dating, a panel can be invited to “evaluate” the date. A chat box, likewise, can be displayed to the host and the panel but not the person being evaluated. The same with the interviewee and its panel.

These and other aspects, features, and advantages of the present invention will become apparent from the following detailed description of preferred embodiments, which is to be read in connection with the accompanying drawings.

### BRIEF DESCRIPTION OF THE DRAWINGS

Advantages of the invention may become apparent upon reading the following detailed description and upon reference to the drawings in which:

FIG. 1 is a diagrammatical representation of a system having a processor and memory with executable code stored therein for providing virtual social networking/online dating services in accordance with embodiments of the present techniques; and

FIGS. 2-10 are exemplary screen layouts of a system and method for live or substantially live multi-point streaming video/audio interaction and collaboration among a plurality of people to interact simultaneously or substantially simultaneously for online dating and virtual social networking in accordance with embodiments of the present techniques.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill in the art and having the benefit of this disclosure.

The present techniques are generally directed to virtual social networking/online dating services employing live or substantially live multi-point streaming video/audios to facilitate multiple participants to interact and collaborate simultaneously or substantially simultaneously via the internet from the comfort of their computer using a single webcam, for example, with a basic internet connection. Yet, it should be apparent that such interaction and collaboration via the internet could be employed via advanced internet connections or other types of internet or networking connections. Further, such interaction via the internet may be conducted from locations other than one's home and on devices other than a personal computer or laptop computer. Also, more than one webcam may be employed on a single computer. The service may also facilitate its consumers to create online audition sessions (set to public or private, for example) by which the interviewer (e.g., a host) along with a group of friends/associates (e.g., panelists) are able to conduct a live online interview with a potential candidate that is interested in dating a particular person whom the audition is being held. The audition session may take place via live multi-point streaming video/audios equipped with a live chat room (text) to allow many or all participants to communicate and collaborate simultaneously via live multi-point streaming video/audios and/or chat or instant chat.

Advantageously, consumers generally will not have to settle for having only a static picture (often a misrepresentation) that depicts the person with whom they are communicating with in this virtual world. In addition, as should be apparent, the discomfort and often bad experiences of the one-on-one interaction with a stranger via the single point-to-point webcam interaction are eliminated or reduced by eliminating or reducing such interaction, such as in certain embodiments via employment of multi-point streaming videos and involvement of multiple collaborative participants. In having the capability to invite or include a number of friends/associates to meeting simultaneously via live multi-point streaming video/audio in one place in a virtual meeting is a solution to a problem with online dating.

In general, the present techniques are designed to respond to the ever-increasing demand of consumers for more intimate interaction in the virtual world of online dating and virtual social networking services. Although useful technologies, such as the tools of email and instant chat (text), are significant forms of communication for online dating and virtual social networking sites, such tools have considerable limitations. For example, they do not facilitate humans to interact face-to-face in real-time via video, which may be more natural than the types of communication found on other online dating and virtual social networking sites. Further, although one can connect with a single partner using a webcam, embodiments of the present techniques provide for a person or member to be interactive and collaborate with a number of friends/associates simultaneously in real-time via live multi-point streaming video/audios from one's computer and/or other devices, and may be a solution to satisfy the desires and demands of consumers today.

Again, the capability is given for an internet user to communicate and interact/collaborate with multiple friends/associates simultaneously via live multi-point streaming video/audios using one or more webcams and a computer (laptop, desktop, or other device) with basic or advanced internet connection. A virtual social networking/online dating service that facilitate a number of consumers to interact and collaborate simultaneously via live multi-point streaming video/audios are beneficially provided herein.

In sum, the techniques may provide for live multi-point streaming video/audios and chat capabilities for virtual social networking/online dating services and other services, as well as provide for capabilities of members to create online audition/interview sessions, which may facilitate multiple people to interact and collaborate simultaneously via the live multi-point streaming video/audios. Further members may be able to access their account and communicate with contacts via live streaming video, file uploading and sharing capabilities between members, email contacts within their account address book as well as non-members outside the site, import their contacts from other services such as Facebook, Twitter, Yahoo, MySpace, Outlook, etc., and so on. The site may also be designed with mobile applications to facilitate members to utilize the site via their mobile phone (e.g., log on, send/receive messages via email, send video messages both pre-recorded and live, view account, and navigate the site). Furthermore, the collaborative capabilities and interactive live multi-point streaming video/audio may be provided through a single site or a reduced number of sites, such as two or three sites. The techniques may provide for direct referrals between members and online video dating including speed dating. Further, in addition to importing contacts, the social/dating service may also interact with other services such as Outlook, Yahoo, Facebook, Twitter, LinkedIn, etc., in various ways.

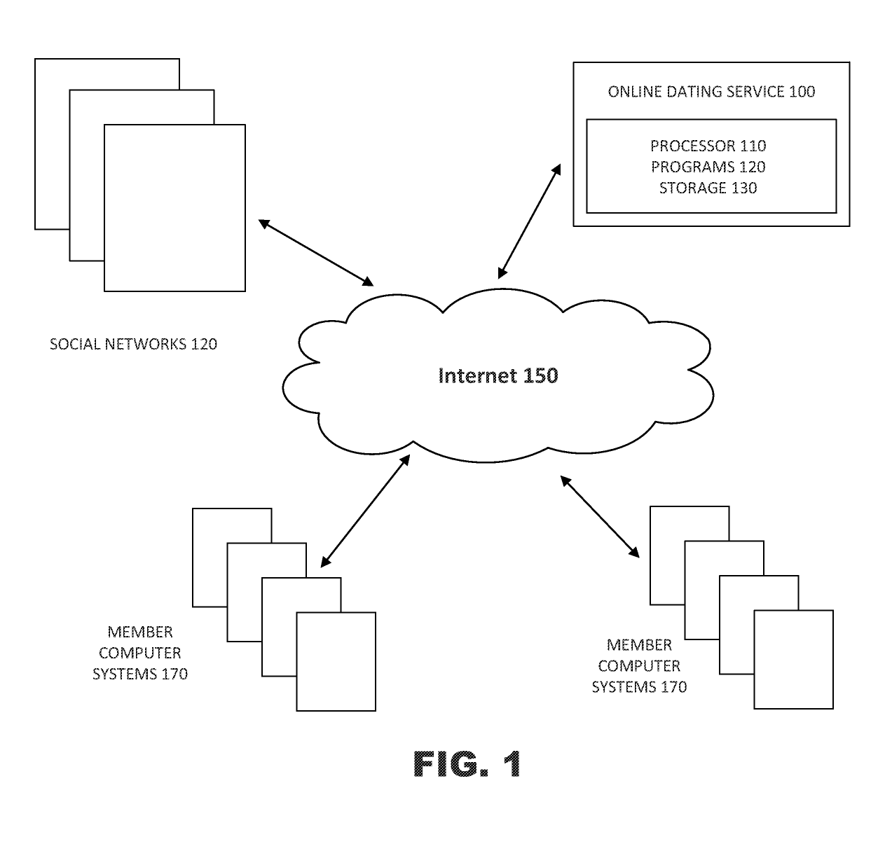

Turning now to the drawings, FIG. 1 depicts an exemplary online dating service 100 having a processor 110, storage 130 with programs 120 stored therein for providing live multi-point streaming video/audio communication/interaction for virtual social networking services and online dating services in accordance with embodiments of the present techniques. The programs 120 will include executable code to facilitate implementation of the present techniques, provide for data entry, display screens, and so forth.

As shown in FIG. 1, a plurality of member computer systems 170 are connected via the Internet 150 to the online dating service 100. These member computer systems 170 will be used by members (or prospective members) of the online dating service 100, and will include various hardware/software to enable audio and video communication, between the member (or prospective member) computer system and the online dating service 100. Also shown in FIG. 1 are social networks 120 which can include various social networks (e.g., Facebook, Twitter, LinkedIn) wherein contacts can be imported. In various embodiments, the present invention can be an add-on feature to one or more of these social networks 120, constitute a separate social network itself, or be an entirely separate and distinct application. In some embodiments, existing members of one or more of the social networks 120 will have an option of joining the online dating service 100, and profile information/contacts may be imported.

Multiple servers, memory devices, processors, network cards and connections, and so forth may be employed. In one example, a server employed is a Dual Xeon Quad Core Dedicated Server having Dual Memory, a 100 Mbps port, Xeon Quad Core—2.13 GHz (Nehalem) Xeon Quad Core—2.13 GHz (Nehalem), RAM 32 GB DDR3, two 500 GB SATA2, RAID-1 Software, Enterprise Linux—CentOS—64 bits, Plesk—Parallels Panel 100, and 1.00—Managed Level 1. In this example, a second server may be a Rage (Flash Media Interactive Server) as a Flex Side server having Streaming Server:—Flash Media Interactive Server 3.5, Simultaneous Minimum Connection:—100 connection, Per Connection 1.5 Mbps, Disk Space:—10 GB, Monthly Transfer:—100 GB. Of course this example is meant to only be illustrative and to not limit the present techniques. Indeed, various other types and sizes of servers, processors, and memory may be employed.

As discussed, the techniques may provide unique live multi-point streaming video/audio communication/interaction among a group of people along with a more advanced chat room or regular chat room, making possible for a virtual social networking and online dating site users to obtain more value from experiences unlike older services. Older services may restrict such intimate communication and interaction. It is believed that offering an online virtual social networking/online dating service which gives live multi-point streaming video/audio session for a group of people to interact/collaborate simultaneously, and which is also equipped with additional features that facilitates live virtual audition/interview sessions, live instant text chat, mobile applications designed for live streaming video, and so on, is a product not available on the market today.

In creating such a unique product, a new branch on the “Tree of Technology” is formed that represents an entirely new category that can be designed to substantially erase the distinction of online/offline dating and online/offline virtual social networking. An intention may be to make the transaction from online virtual social networking and online dating to the real world as natural and seamless as have been done in the telecommunication industry (cell phones). The techniques offer a unique product that responds to the most pressing needs and desires of real people—the need for substantive and wholesome interactions in a natural way. Such is a virtual world where they are able to see real-life images, mannerisms, expressions, physical reactions to questions/comments, identify personality traits, etc. in addition to having other participants simultaneously present and interacting/collaborating in a single session in real-time. Herein is an opportunity to offer consumers a service to satisfy their demand.

An objective may be to provide people a way to interact via live multi-point streaming video/audio, conduct live online auditions/interviews, and share information (sometimes in an easy and entertaining way), and to provide live multi-point streaming video/audio based virtual social networking. In certain examples, a site or sites employing the present techniques may provide several ways for a member to find friends:
Members may be allowed to browse and join networks, which are organized into multiple categories (e.g., four categories): regions (networks that are linked to specific cities or countries), colleges, workplaces, and high schools, and so forth. Once a member joins a network, he/she may then be allowed to browse through a list of members within the database and search for people they know. Members may be searchable by age, sex, relationship status, political views, and other criteria;
Members may be able to allow the site to pull contacts from Web-based e-mail accounts, for example. To do this, members may give the site their e-mail address and password. The site's program searches through a member's e-mail contacts and compares his/her list against its membership database. Whenever the site discovers a match, it may provide the member with the option to add that person as a friend or associate to his/her account; and
Members may also be able to allow the site's search engine to look for a specific person. For example, the member may type the person's name or member ID into the search field, and the site will then display profiles that match the name.

A member's profile may be the Web page other members will see if they look him/her up. It may be designed to give other members an idea about who a member is and what his/her interests include. It may be assumed that many of the people with whom its members want to connect share the same hobbies, member of the same organization, work for the same company or industry, went to the same school or live in the same town as they do, and so forth.

To facilitate finding friends both old and new, the present techniques may be designed to gather information about a member and others to create a dense network of contacts. In certain embodiments, a member may be able to see and make contact with mutual friends/associates, old classmates or coworkers who have accounts. Indeed, it may be structured such that members will be facilitated to find each other. In this example, when a member receives a contact from someone they do not know or choose not to add as a friend, he/she will have the option to choose not to answer questions or to adjust privacy settings so that others can't find them.

In a particular example, a member's unmodified profile may have, among other information and functions, the following:
A space where you can upload a profile picture, introductory video clip, images, and files;
A friends section, which displays pictures of members one has befriended;
A section that shows the personal information members has decided to share with other members. (birthday, work history, education, video clips, messages from other friends/associates, upcoming and past audition session, and/or other interests); and
A mini-feed section will inform and display messages to visitors of a member's account regarding the member's activities, updates (changes to his/her profile picture/video clip), notifications, alerts, etc.

There may also be an area within a member's profile that allows other members to leave messages for them via instant message, which opens up a site-specific application IM client, send the person a message in an e-mail-like format or video clip, and make a request to the person to add them as a friend/associate which the member can either accept, reject or ignore, etc.

In operation of some embodiments, when a member logs into his/her account, he/she may arrive at his/her personal dating/social service homepage of the site. This homepage layout may include a social feed designed to keep members updated about what their friends and networks are up to. There may be also a status update section, which contains notices about messages the member has received, invitations to events, upcoming and past audition sessions, notices about applications friends would like the member to try and a place for the member to share his/her feeling or discuss other topics. Further, there may be a link that lets members invite friends to join the sites of the present technique. Moreover, in certain embodiments, business owners, artists, bands and public figures, and the like, can make special profiles. In other words, instead of becoming friends with the owners of these accounts, regular members may become “social pals”, for example.

Members may also be allowed to customize their profile using applications provided by the present techniques. These applications may set it apart from other social networking sites. First-party applications may include photos, videos (both pre-recorded and live), groups, events, marketplace, posted items, and notes. These applications developed and offered via the present techniques may be made available to most or all members. Below are examples of applications.
The photos application may allow members to upload images (e.g., as many as he/she pleases). In certain instances, if a member has a picture of another member of the site, he/she will be able tag the photo with the member's name. After tagging the photo, it may appear both in the member's photo album and on the member's friend's profile.
The video application may facilitate members to upload videos (e.g., in almost various format), but the site may request that there be a limitation on file size and video length (e.g., files remain below 100 megabytes and that videos be shorter than two minutes). Moreover, the site may convert videos into the flash (.flv) format, for example.
With the groups' application, members may be able to join other members' interest groups or simply create one of their own.
The events application may allow members to invite other site members to a real-life such as such as clubs, restaurants, book readings, etc. or live multi-point video streaming gatherings.
The present technique may let members connect with others interested in buying and selling things. Transactions may occur directly between members with the site hosting the exchange.
The posted items application can be used to post videos, songs or other items on a Web page to a member's profile. In one example, members enter the Web page's URL into the post field on the site. The application may generate a thumbnail of the target page that acts as a hyperlink. Member friends may be able to click on the thumbnail to visit Web sites the member finds interesting.

Sites of the present techniques may also remain innovative and continue to accommodate new applications for its members. The sites may grant its members freedom to develop applications. For example, users may be given access to an application programming interface (API), which lets users develop applications using the host site as a platform. Further, third-party site applications may diversify members' experiences on the site by providing for videos, product reviews, games, and virtual pets, and so on.

As indicated, the problems with other virtual social networking and online dating services is that they do not provide consumers with the capabilities to interact/collaborate via live multi-point steaming video or live multi-point streaming video/audios for audition/interview. When people think about video conferencing, they may think in terms of universal connectivity—that is, the ability to call from anywhere to anywhere. And people also may want to be able to include various kinds of users in their discussions—ranging from the people in corporate headquarters who can gather in video conferencing rooms to those individuals who will be connecting over the Internet from home offices, for example. In addition, the technology of video conferencing continues to be primarily associated with corporations and for business use with the exception of the off-the-shelf point-to-point webcam produces for home use. Importantly, no other virtual social networking sites nor online dating services have taken advantage the amazing technology of live multi-point streaming video/audio.

The present techniques may make dating less of a guessing game, more appealing, and safer then the prior online dating services. For the members that will be interested in using the present site's service to socialize outside their network of friends, family members, associates, and colleagues, a second basic application may be employed—an added service through which members will be able to discover potential mates or dates. The second basic application is video-based as with the overall first basic application, but it may be considered an entity within itself with proprietary features, functionality, and capabilities different from that of the overall application.

For someone looking for love or romantic relationships online, physical appearance is typically a factor in their decision in whether to commit to a date or not. However, photographs associated with sites of the past may be digitally enhanced, unrepresentative of the person, or simply taken from a by-gone era, so it is no wonder people end up disappointed after having meet the person they viewed in an enhanced photograph or dated photograph they were so excited to meet in-person. Indeed, with blind dates, many people may not receive an accurate representation of what the person (their date) actually looked like. In response, the present techniques may provide for seeing an introductory video clip or picture of a potential blind date, which may affect a decision as whether to meet in person. In addition, live video based audition sessions may be offered to allow friends/associates of a member interested in finding a date/mate to audition/interview potential candidates on behalf of the member before contacts with the member are made from potential candidates. The audition session may consist of a host, panelists, and an interviewee. An invitation may be sent to potential candidates, and auditions sessions scheduled accordingly. The host may be the lead person to conduct the audition/interview with the interviewee (potential candidate) and the panelists may be also be presenting via live multi-point streaming video/audios (as will instant messaging) to communicate with potential blind dates. The host and panelist may chat via the chat room (instant text) and via live videos. The host may have admin right to either allow the interviewee to interact with the panelist or to make the panelists invisible to the interviewee. Such a process may be designed as a filter system to identify qualified potential dates and move them to the next round of the audition session or disqualified the non-compatible candidates from meeting the member seeking a date. As should be apparent, this may help alleviate certain discomforts and stigma often associated with online dating.

As indicated, present sites may facilitate a member or user to employ a webcam in an IM session to assist a decision to meet in person. The present techniques uniquely provide virtual social and online dating services with live multi-point streaming video/audio communication (allowing a user to even see the body language of the person he/she is communicating with, for example). This unique application of live multi-point streaming video/audio can potentially make blind dates less ‘blind’ or create comfort and support for the person that is not comfortable being alone in a one-on-one live video session with a stranger or someone they are meeting for the first time. A significant beneficial shift in social interaction. Although many people still receive an old photograph—digital or otherwise—or a verbal description of their potential date, a live multi-point streaming video/audio session in which one is able to have friends/associates accompany them to experience the full process first-hand and in real-time may help to bring truth to life in a much more real and trustworthy way while at the same time makes it easy for one to ‘test the water,’ before investing too much of their valuable time into or even agreeing to meet a potential date/stranger in-person.

Live multi-point streaming video/audio may be a beneficial way to interact, live and in real-time, without one being required to leave the comfort of their home, office or any other place one may be situated. It also facilitates people to interact in a live multi-point streaming video/audio session simultaneously as a group, which will facilitate them see each others detailed facial expressions, for example, and other personality indicators such as laughing at a joke, acting silly or seeming shy, and the like. What is more, if people realize through a live multi-point streaming video/audio session that they are not interested in meeting again, it is relatively easy to sign off, without wasting the additional time, money and energy associated with meeting someone in-person.

The little deceptions people may make online without video streaming can turn into disappointments when a date is finally met face-to-face. By being able to meet online with a video call, one is generally more able to pick and choose a potential date and waste less time and money that may go into organizing a first face-to-face meeting. Being online and chatting over video may increase the chances of avoiding potential disappointment. The techniques may provide efficiency or improve efficiency. People may introduce a potential date to friends in a live multi-point streaming video/audio session where everyone is in one place simultaneously, irrespective of their physical geographical location. As a result, individuals may spend more time online getting to know a prospective date before actually arranging a face-to-face date. People are generally looking for alternative routes of finding a partner. Joining a dating site typically costs a fraction of the amount you would spend in a night at a bar without having met the right person. People that go to bars or other social settings, for example, to look for a potential partner may instead employ online matching sites.

As described, the present techniques are unique hybrids of virtual social networking sites, online dating services, and live video conferencing. In contrast to the present techniques disclosed herein, it is believed that no social networking or online dating services offers the capabilities for internet users or other network users to communicate and interact with multiple partners simultaneously via live or substantially live multi-point streaming video from most or all parts of the world.

Conversely, the present techniques may be designed to cater to consumers needs. Unlike other online dating services, the present techniques matching system is designed with the beneficial aspect in which to help individuals make the right choices in selecting their ideal or desired date, mate, or friend—human intelligence. Instead of relying on or just relying on artificial intelligence to provide humans with a “calculated match” in regards to aiding them in finding a potential future mate or companion, the present techniques facilitates its members to interact and communicate among themselves in order to draw their own conclusion. Though, matching algorithms and artificial intelligence may be employed if desired with the present techniques.

The present techniques are designed to facilitate the natural innate instinct, intuition, and experience of both the candidate themselves and their personally selected and trusted friend in helping to make such important decisions. The site generally leaves control of the process in the hands of the seeker so that they are substantially free to navigate their way through the many choices in their quest to find the right person with whom to establish a short or long term relationship. The values and qualities that are common in both the seeker and the one being pursued surface and are discovered as people are free to interact among themselves in the most natural and unconstrained way via live multi-point streaming video/audio. As the pieces of the puzzle are set in their proper places during the live audition process and speed dating sessions, it is not long afterwards when all participants are able to see the value in such a technique which is design to aid them in creating experiences that lead to favorable results.

As indicated, the second basic application may provide for auditions or auditioning. Multi-point streaming video may be provided and such action may be coordinated through a single hub site. Thus, the participating members may be in a sense anonymous. Such auditions may provide for a direct referral, i.e., a member's friend may refer potential date or mate to the member.

It should be noted that in certain embodiments, the friends need not be full members seeking to find date or mate for themselves. Moreover, advantageously, the audition process may ultimately conclude in an on-line video date (e.g., a first date or speed date). Friends may witness such dates. Further, in embodiments, other members may be granted permission to witness auditions and such dates, and vote, comment, or blog, for example. As indicated, certain witnesses may be granted a limited membership, e.g., without search or hosting capabilities or other capabilities, but with a free or discounted membership to watch auditions or dates open to the public, limited public, or designated group, and so on.

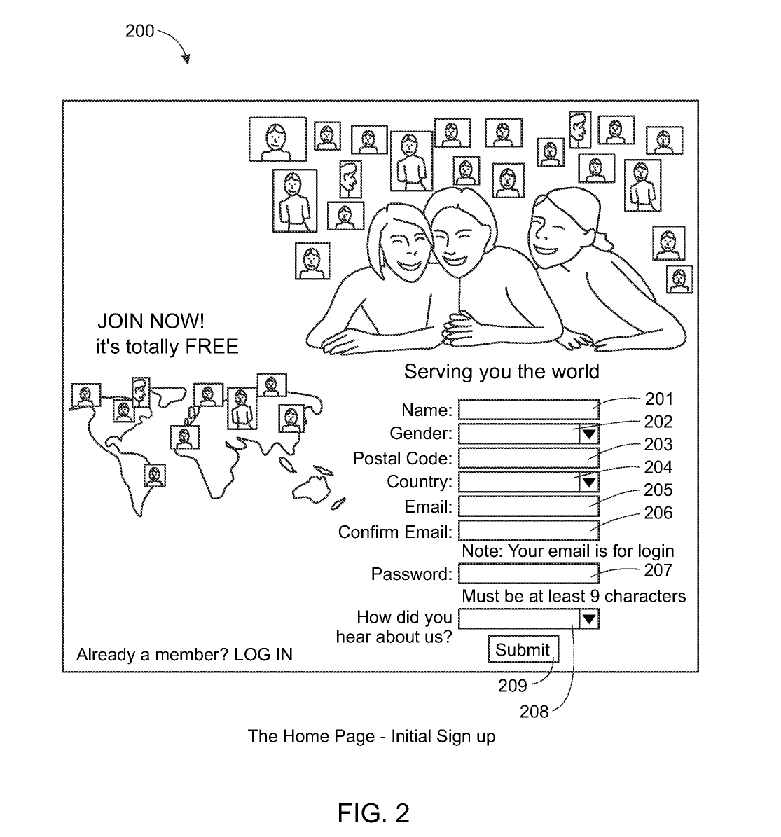

Returning to the drawings, FIGS. 2-10 are exemplary screen layouts of a system and method for live multi-point streaming video/audio interaction in social services including dating services involving auditioning of embodiments of the present techniques. FIG. 2 is an exemplary “New Member Registration” page 200 providing for an initial member sign up. Various fields are provided for data entry (e.g., using text boxes, pull-down menus, check boxes) by the potential member. Such fields may include the new member's first name 201, gender 202, postal code 203, country 204, email 205, confirm email 206, password 207, and so forth. Additionally, information may be gathered as to how the user became aware of the site, such as by providing a “How did you hear about us?” pull-down menu 208. Once the information is provided, the potential member can submit the form 200 by clicking on a Submit button 209, for example. Of course, other fields (and more or less number of fields) than those depicted may be utilized. In certain embodiments, the illustrated exemplary sign-up page may be for enrolling a member into a site application where auditions having multi-point streaming video (and accompanying text chat) may be employed live or substantially live.

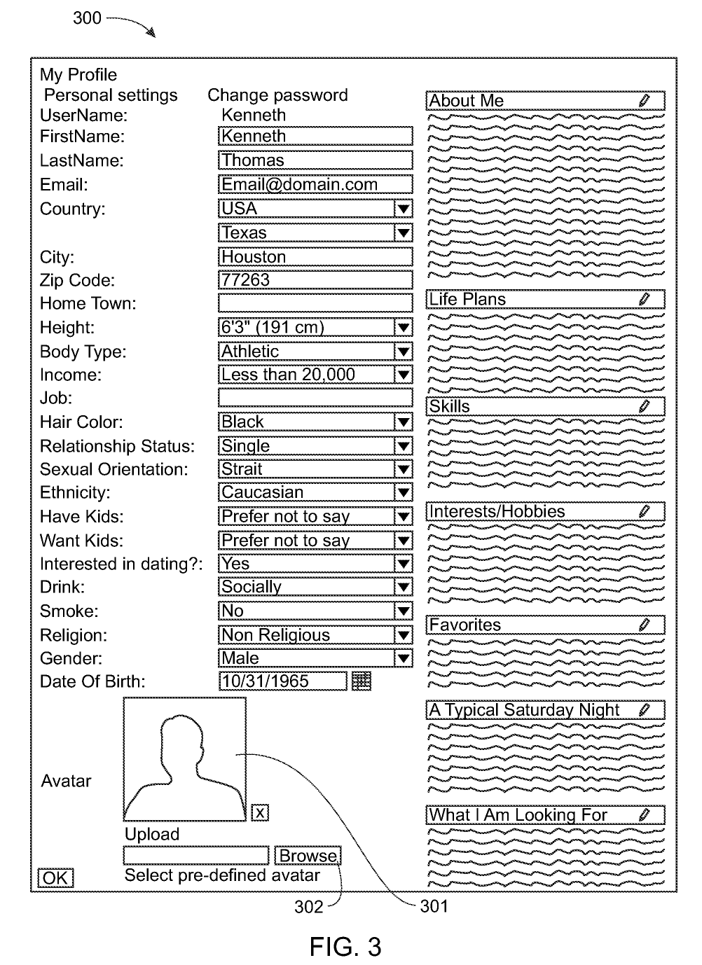

FIG. 3 is an example “Profile” page 300 that provides for a new member to set up their profile. The new member may also use such a screen to upload a pre-recorded introductory video clip of the member (not shown). In the illustrated embodiment, various pull-down menus are provided for the member to input basic information, such as height, weight, body type, and so on. Extra information (e.g., a title, general information about the member, etc.) may be entered as text in fields accepting a certain amount of characters. Links or hyperlinks may also be listed for uploading photos or video, viewing photos or video, adjusting settings, viewing account information, and the like. In general, such a profile management page may be implemented for members in view of the technique that members may participate in interactive and collaborative auditions having several participant members and employing live multi-point streaming video/audio. Finally, in the embodiment shown herein, the member may select a predefined avatar 301 using avatar selector 302. In other embodiments, the member may, alternatively, upload a photo of themselves in place of the avatar 301 (in .JPEG format, for example).

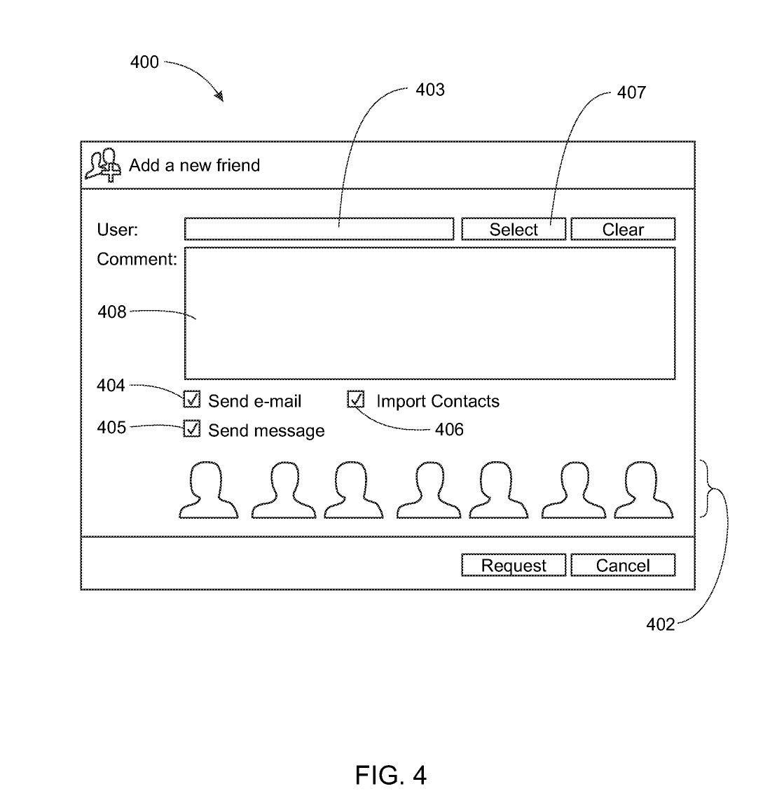

FIG. 4 is an exemplary “Add Contacts” page 400 for adding new contacts to the member's address book or contacts. As mentioned, the techniques may allow the member to import their contact list from other systems, such as Facebook, by selecting, for example “import contacts” check box 406. In this example, the images of the member's contacts 402 are displayed as static images that act as thumbnails, which when clicked on will play the individual's pre-recorded introductory video clip of themselves. In this example, buttons or links may be provided for adding friends, sending emails, sharing information, and so forth. For example, the member may enter the potential contact's user name in user name box 403. The member may write a comment in comment box 408 and choose to send it as an email by selecting “Send e-mail” check box 404 and/or as an internal message by selecting “Send message” check box 405. The member may send the comment to the potential contact by click select button 407. Further, audition panelists may be selected. For example, an invitation via email requesting participation in the audition session can be sent to each selected friend. The selected friend may accept or decline the invitation. If accepted, the friend will receive a second email which will contain information (i.e., username, password, meeting ID, and meeting date/time) for a video conference meeting with the member (host) on behalf of the member they received the first email invitation regarding to discuss the audition.

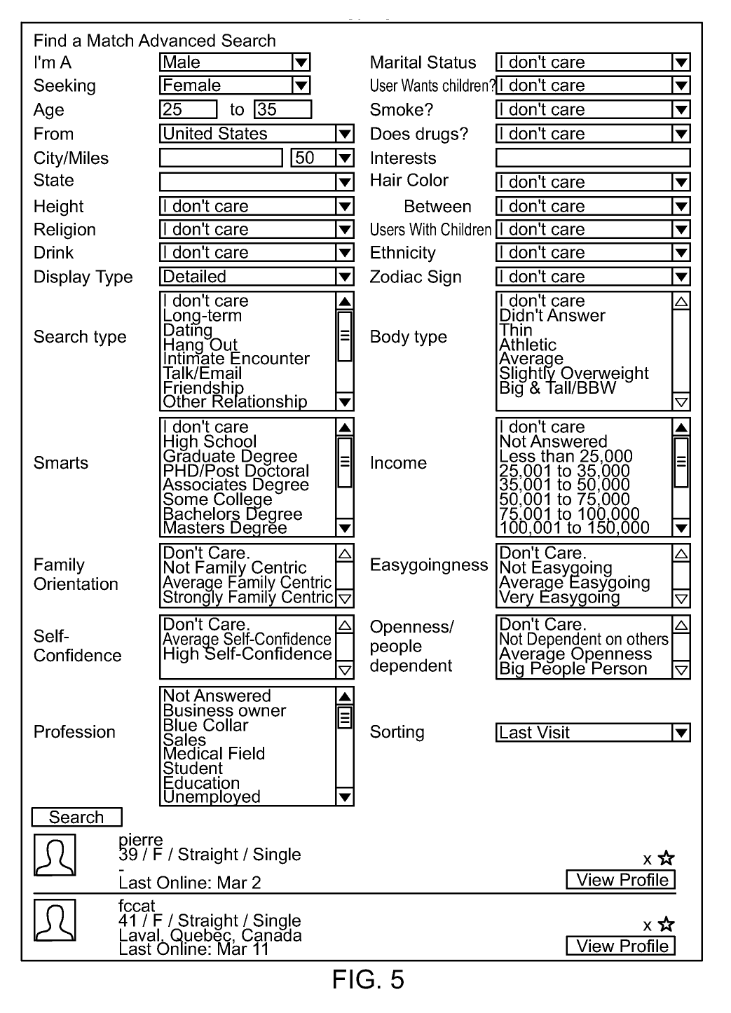

FIG. 5 is an exemplary “Search” page 500 in which members can select specific characteristics (e.g., race, age, height, habits, etc.) of the type of individual they are interested in dating. Various types of searches, such as quick searches, custom searches, and so on, may be employed. Moreover, advertisements may be placed on the illustrated page, as with other pages of the figures.

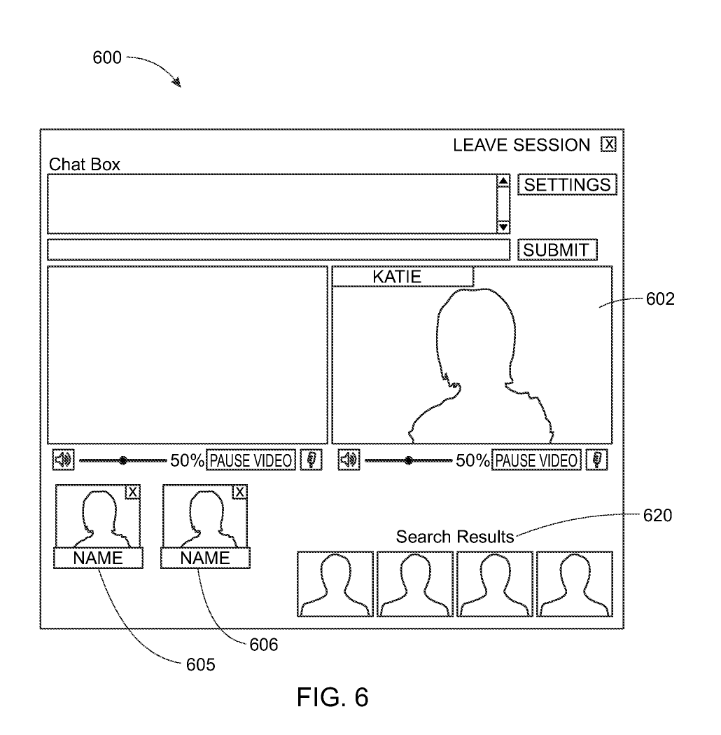

FIG. 6 is an exemplary “Audition” page 600 where an example person, Katie 602 (host), is on a live video conference with two of her friends 605, 606 viewing her search results 620. With two or more of the women communicating via live streaming video, the images of the men in the search results 620 are static. As Katie 602 or one of the friends 605, 606 mouse over an image of the men in the search results 620, the image enlarges and shows a caption of the person's name, age, city/date of residence in this example. In the illustrated embodiment, Katie 602 and her friends 605, 606 are able to click on an image (i.e., of one of the men in the search results 620) and view that individual's introductory video clip. As Katie 602 or her friends 605, 606 make their selection of each person or man (e.g., she finds interesting or attractive), the person or man is placed in a queue in this example. An exemplary title of this initial queue may be “First Round Draft Picks.” Though, many other applicable titles may be utilized. Indeed, in certain embodiments, members will be able to customize titles and names of the sessions they host.

Once Katie 602 has made her selections of individuals she finds interesting and they are placed in queue, she may then select one of her friends to lead the audition. Of course, on the other hand, Katie 602 may select one of her friends 605, 606 to lead the audition, before or during making selections of individuals (men) she finds interesting. Nevertheless, this selected friend will then become the host (of the audition). Other selected friends will be recognized as panelists. The chosen host of the audition may send an invitation to one or more of the men or persons selected for an audition placed in the initial queue to participate in an audition session to be interviewed for a date for Katie. Such an invitation may be sent via email or mobile phone or other device/technique and contain an invitation (e.g., a short invitation statement) from the host, as well as a link to Katie's profile along with her introductory video clip, for example. The invited man or person may either accept or decline the invitation. In this embodiment, if the invitation is accepted, the man or person may receive a second email containing a username, password, session ID, and time/date for the upcoming audition, for example.

Note that in various embodiments of the present invention, a different number of individuals can communicate via live multi-point streaming video/audio from the number illustrated in the example. Preferably, the host and the interviewee will be able to invite up to six (3) friends/associates each to participate as their panelists, and all of them will be able to communicate via live multi-point streaming video/audio and live chat. Of course, in other embodiments, more or less panelists may be invited and participate.

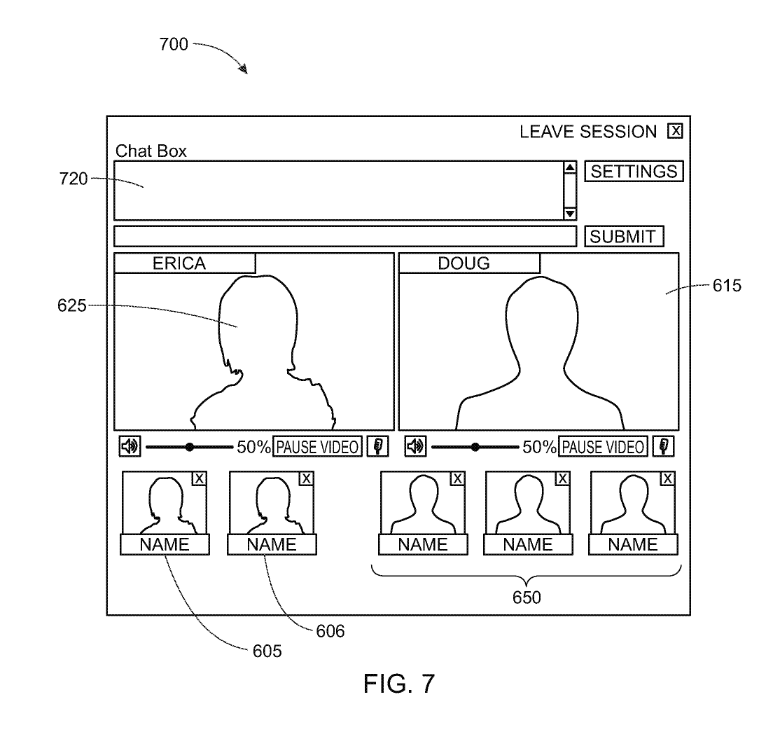

FIG. 7 is an exemplary page where an example person, Erica 625 (host), is in a live multi-point streaming video/audio session with a man, Doug 615, selected by Katie 602. The two other friends, Sarah 605 and Renee 606, are also participating via live multi-point streaming video/audio as audition panelists. However, in this example, the friends (panelists) 605, 606 are invisible and muted to Doug 615 (the interviewee). The panelists 605, 606 are also mute to Erica 625, but are communicating with her via live chat in the chat room box. Of course, other implementations may be realized, such as the panelists communicating via audio with Erica having a separate earphone, for example. Most or all of the women can see each other and correspond via multi-point streaming video and live chat via the chat room box. Although this page, which represents Erica's 625 (host) computer screen, shows the panelists 605, 606, and chat room box 720, the computer screen of Doug 615 (interviewee) may not disclose this content. For example, Doug 615 may only be able to communicate via live streaming video with the Erica's 625 (host) and may only be able to see advertisements and Erica's 625 (host). In one example, only the host and the panelists or other selected individuals are able to see the same content or similar content on their computer screen. Same with Doug and his panel

As should be apparent, auditions may be held on different times and days. As the host and the panelists complete an audition, they may be able provide a rating for interviewee or cut them. The host may also be able to eject, disable, make invisible, and terminate any participants from the audition. The also be able to stop or terminate the audition session at any time. The host may also be able to provide a rating for each panelist, which may be based on their effectiveness and involvement during the audition session. The more desirable interviewee's are selected to move to the final picks, which can be indicated on the lower right side of the screen. After the host and panelists have made their final picks, they may reconvene with Katie 602 to discuss their choices. It should be noted that the person (e.g., Katie) for whom the audition is being conducted to find him/her a date can also sit in as a panelist and be invisible to the interviewee as generally will be the other panelists. Of course, the host of the audition can choose to allow all parties to see and communicate via live multi-point streaming video/audio with each other. Thus making all participants visible to each other.

After the host, panelists, and Katie 602 have had a discussion, the next part may be to notify each of the qualified interviewees that he has been selected to move on as a final pick. Generally, the interviewees may not be aware of each other. Either Katie 602 or the host, for example, may send out an invitation to each of the Final Picks to have a date (e.g., a short online speed date) with Katie 602, which may be conducted via live multi-point streaming video/audio.

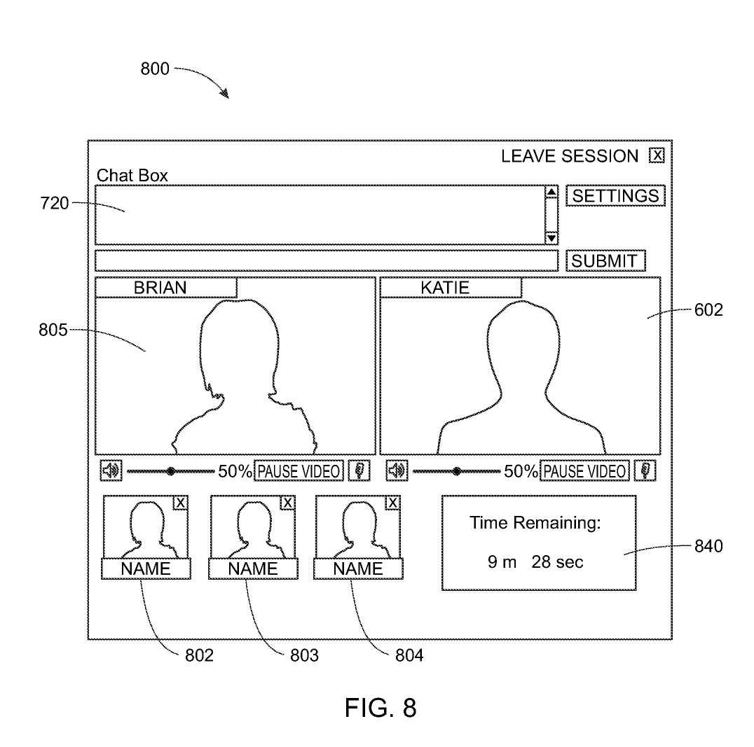

FIG. 8 is an exemplary “Online Speed Date” page 800 depicting Katie 602 online with Brian 805 (e.g., a final pick). Katie's friends 803-805 are also participating via live multi-point streaming video/audio. However, the friends 803-805 may be invisible to Brian 805 and may be able to only communicate with Katie 602 via live chat in the chat room box 720, for example. In this embodiment, Brian 805 is unable to see Katie's friends 803-805, the depicted chat room box 720. Brian 805 is primarily only able to see Katie 602, advertisements, and any other innocuous items. These speed date sessions may be based on a limited time (e.g., 30 minutes or so). Preferably, the amount of time remaining is displayed, such as in remaining time display area 840, as shown. Katie's friends 803-805 are in essence eavesdropping on the session and sharing their contemporaneous comments with Katie 602.

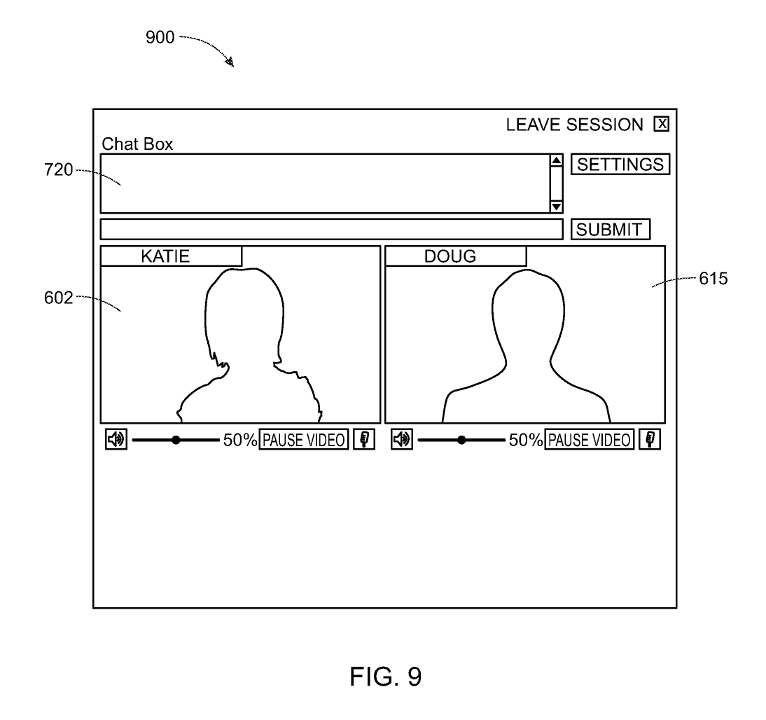

FIG. 9 is an example “Video Date” page 900 depicting Katie 602 on a live streaming video date with Doug 615 (e.g., her pick). Although FIG. 9 depicts a “one-on-one” date, in various embodiments screens showing a double dating session (i.e., two sets of couples) can be realized.

FIG. 9 is an example “Video Date” page 900 depicting Katie 602 on a live streaming video date with Doug 615 (e.g., her pick). Although FIG. 9 depicts a “one-on-one” date, in various embodiments screens showing a double dating session (i.e., two sets of couples) can be realized. (Statement made twice)

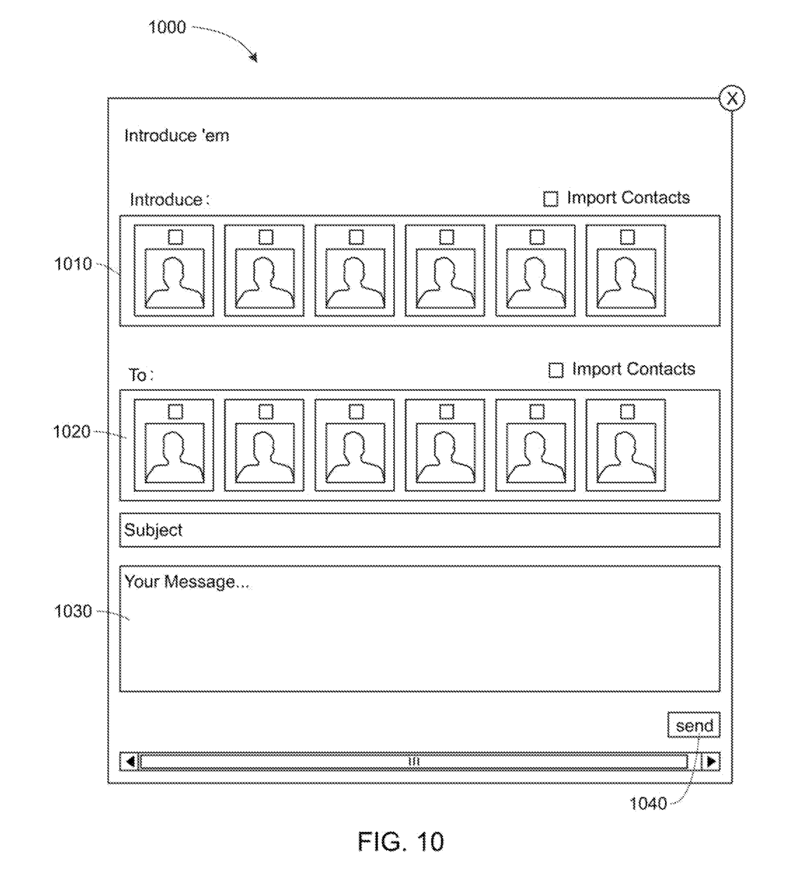

FIG. 10 an “Introduce 'Em” screen 1000 useful for a member to refer other members to their friends. Preferably, the “Introduce 'Em” screen 1000 is a pop-up screen which can be invoked anywhere from within the system. Once the “Introduce 'Em” screen 1000 is invoked, the member selects a first set of contacts 1010 to refer to a second set of contacts 1020, then includes a message in message box 1030. After submitting the message by clicking on send button 1040, the second set of contacts receive the message. Preferably, the first set of contacts 1010 can also receive a copy of the message and the list of contacts in the second set of contacts 1020. The above described screen is very useful not just for dating purposes but also for business referrals.

The present technique may also help to prevent non-compatible and unfavorable individuals from even making contact with other members they may be interested in. Indeed, the real-time participation of multiple members in a live multi-point streaming video setting may discourage certain members from committing unsavory acts because there are multiple witnesses, for example.

Further, in general, various security applications may be employed. In one example, a comprehensive network security may be deployed. Such security applications (e.g., by Cisco) may provide adaptive security appliances integrate firewalls, unified communications security, VPN technology, intrusion prevention, content security, and so forth. Some or all of these components may be integrated in a unified platform. The security applications may work to:
Stop attacks before they penetrate the network perimeter;
Protect resources and data, as well as voice, video, and multimedia traffic;
Control network and application activity; and
Reduce deployment and operational costs.

Security appliances (e.g., Cisco ASA 5500 Series Adaptive Security Appliances) may also provide:
Adaptable architecture for rapid and customized security services deployment;
Advanced intrusion prevention services that defend against a broad range of threats; and
Highly secure remote access and unified communications to enhance mobility, collaboration, and productivity.

The present techniques may also encompass mobile (cell phone, etc.) social networking or mobile dating services. Mobile devices may be employed to maintain contacts, store details about people, and assist in meeting new people for dating, business or friendship. GPS or triangulation may be utilized to identify a member and their location. Lastly, it should be noted that while the foregoing discussion throughout has focused on online social/dating services, the present techniques may be applicable in other contexts, such as in business, education (schools), government, doctor/patient interaction, and so forth. For example, employing the present techniques in a school setting, parents (regardless of each person's geographical location) could join a live multi-point streaming video/audio teacher/child meeting from their computer or mobile phone and interact and/or collaborate with a teacher or both the teacher and child. The parents may also be able to also interact/collaborate with more than one (seven or more for example) of the their child's teachers simultaneously without any of the participants leaving their office, home, or classroom as long as they have a computer or mobile device equipped with basic internet connection and a webcam. All participants are able to physically see, interact, communicate and share files/documents amongst each other in a real-time virtual setting just as though they are all physically located in the same room sitting across from each other.

The present techniques may provide for the intellectual or aesthetic taste for friendly interactions and/or companionship, simple tastes for straightforward interactions, and the like. The techniques may include online dating services, virtual social networking, live multi-streaming video and web conferencing applications, live online audition sessions, mobile communication with live streaming video, and so on. Indeed, the present techniques may provide unique combinations of these components, and potentially serve a wide range of needs and desires of a charged and anticipating market. Customers, members, users, etc. may be less constrained by the limitations of the relevant prior art. In fact, the current techniques disclosed herein may provide internet users freedom to indulge themselves in an aggregated variety of tailored services relevant to their specific needs, wants, and desires to mingle, interact, and socialize (e.g., in a single place) and be connected simultaneously via live multi-streaming videos. Furthermore, the present techniques may interact with other established services, such as Yahoo, Facebook, Twitter, LinkedIn, Outlook, mobile devices, and the like.

It is believed that the economic climate and markets are ripe for a new and more innovative hybrid virtual social networking/online dating service that allow consumers to interact and collaborate as a group simultaneously (or substantially simultaneously) via live (or substantially live) multi-streaming videos with friends/associates and others outside their normal circle of contacts. Such service may be customized to serve specific or general purposes, such as facilitating people the freedom to socialize, network, seek potential mates, and interact via live multi-streaming videos under one umbrella in certain cases (or a limited number of umbrellas). While there seems to be a tug-of-war between the online dating market and the virtual social networking segment to service the same consumer base, consumers are in demand of a more immediate and intimate means of communicating/interacting with each other in the virtual world that offers a one-stop-shop approach in certain embodiments which facilitates consumers or members to take advantage of virtual social networking, online dating, and live multi-point streaming video/audios interaction/collaboration in one place in certain examples.

Adults find socializing, commonality, mutual sharing, and common experiences among other factors through which possible friendship or long term relationship can exist something the prior online dating services lack. Therefore, it is not surprising people are gravitating toward social networking sites. Analysts are reporting that an increasing number of internet users are spending more time on social networking sites then dating sites because it allows them to interact with friends/associates and others outside of their normal circle of contacts for purposes beyond trying to find a mate.

Nevertheless, it is not believed that online dating will disappear as a result of the phenomenon of virtual social networking. However, if online dating is to maintain its position in the market, it must evolve to retain the prominent market share it has enjoyed for nearly two decades. Consequently, the present techniques provides a unique mixture that incorporates online dating, virtual social networking, and the capability for users to interact simultaneously as a group via live multi-point streaming video/audios (facilitated through a single point). In certain embodiments, the techniques may provide a unique and customized divergent of internet dating, virtual social networking, live video conferencing, live streaming video via mobile phones, and so forth.

The demand to maintain a healthy personal and professional social life has fostered entirely new and innovative community over the past few years often referred to as virtual communities, e-communities, online communities, and the like. Such a community's purpose may be to provide virtual social networking. Further, according to the present techniques, this type of networking may address the ever-present demand on a user to prioritize and efficiently utilize time.

Millions of people, irrespective of their geographical location, continue to adopt this revolutionary means to keep in contact with friends, family members, associates, businesses, and with others outside of the circle of contacts. Accessed and integrated via a computer network, virtual social networking has helped to remove or reduce limitations consumers faced prior to the introduction of virtual communities in not being able to keep in touch with friends/associates and the ability to forge new friendship due to the time restrains associated with the demands of work and family obligations and other obligations. Increasingly, virtual communities have had a global effect on the social evolutionary aspect of mankind. It is recognized as and has become, to a large degree, the default choice or a significant choice of communication among consumers. Considerable sociotechnical change has resulted from the proliferation of virtual communities.

Virtual social networking has overtaken email as the most popular internet activity in terms ways people choose to stay in contact. What is more, the reach of social networking and blogging venues is growing at twice the rate of other large drivers of internet use, such as portals, email, and search. A social networking site is a way through which people connect to each other from around the world via the internet, and thus, creating a network of contacts. Such a network can be professional, personal, interest based, or purely social. Virtual networking has become relatively convenient for internet users to keep in touch with friends (both old and new), associates, professionals, and the like, from computer via the internet.

Social sites may typically be used by its members and visitors as sources for finding dates. While that may not be the primary objective of these sites, they do provide opportunities for individuals to meet people for reasons beyond networking. Social networking sites may recognize this behavior and allow their members to specify their relationship status and allow them to search for someone for either a friendship or as a possible mate. Generally, people of all ages, ethnicity, and backgrounds may take advantage of this powerful online tool, for example, to enrich their lives through the contacts they are able to make.

A person generally does not want to be inundated with unsolicited spam friend requests. Therefore, attractive social network sites may keep profiles and search options, such as private enough so that the only people that can find a member are the ones actually looking for users in their own school, neighborhood, or friends networks, for example. Even with a completely public profile, users may be protected for the most part and may only experience no more than a few unsolicited comments or messages on an irregular basis.

Besides establishing social relationships, social networking members can share their interests with other like-minded members by joining groups and forums. It also offers opportunities for members to find jobs and establish new business contacts among other things. Also, in addition to blogs and forums, members can express themselves by designing their profile page to reflect their individual personality. The most popular extra features include music and video sections, in which individuals are able to upload and share their favorite funnies and videos with others. Members can also search classified, read bios of their favorite music artists from the artist's profile page, as well as, listen to songs and watch commercials. The video section includes everything from member-generated videos from hundreds of subjects to TV clips and movie trailers, and the like.

Online dating is another and arguably a more advanced technique through which people use the internet to scope out the vast variety of “fishes in the sea” in hope of identifying individuals (both single and married) they might find interesting and/or whom in some way share their aspiration and intention—love, friendship, flirt, fling, romance, and so forth. The capability to spouse-hunt online can be significant for most or all age groups. The sheer size of the Web audience make it possible for people to effectively check out profiles generally from a far larger pool of people than they could offline. Moreover, this relatively new online approach may have substantially lost the stigma it once possessed. A cultural shift has generally made it socially acceptable for a person to put out a singles ad or create a profile on a dating site without feeling odd about doing so. Many now do not accept the once potentially embarrassing feeling of being perceived as odd for going online to find a potential mate. Such perceptions have been replaced for many people with the logical reasoning of being a busy person simply seeking an alternative way of finding time to socialize. It is more of a time management situation rather then an act of desperation. People of all ages may generally use these advantageous tools to increase their chances.

Online dating services may run on a curious mix of technology, science, alchemy, and marketing. They may combine large databases with business intelligence, psychological profiling, matching algorithms, and a variety of communications technologies to match up singles. In match making, online dating sites may be search engines—big, searchable databases. Users fill out a short personality profile with check-box items and short descriptions about themselves. In some examples, once an account is set up and the required membership fee is paid, the user is then allowed to begin his/her search. Of course, in other examples, a member may conduct a search before a membership fee is paid. To narrow the choices resulting from a general search, site members may filter prospects using criteria such as gender, zip code, race, religion, marital status in addition to whether or not a person is a smoker, for example. Users may filter through the results themselves and decide (on their own) which prospects to pursue.

“Scientific” matching services may attempt to identify the most compatible matches for the user by asking anywhere from a few dozen to several hundred questions. The services then assemble a personality profile and use that against an algorithm that ranks users within a set of predefined categories; from there, the system produces a list of appropriate matches. Some sites take a combination approach. For example, recommended picks may be issued but members and visitors may also browse the “inventory” for themselves.

The technology that powers dating sites may range from somewhat simple to relatively complicated. The sites may include one sophisticated data center, terabytes of data on millions of registered users, each of whom has filled out a multi-question profile (including psychological profiles). The sites may use algorithms to score that data against “dimensions of compatibility”—such as values, personality styles, attitudes and interests, and the like—and match up customers with possible prospects for a long-term relationship.

Large databases may generate preliminary candidates after a user signs up. More detailed matching may happen later, after the site system scores and matches up answers of up to hundreds of questions from up to thousands or more users. The process can utilize up to a billion calculations or more, that may be processed in a large batch operation (e.g., each day). These operations may execute in parallel on hundreds of computers and may be orchestrated using software written in various platforms.

In certain instances, once matches are sent to users, the users' actions and outcomes are fed back into the model for the next day's calculations. For example, if a customer clicked on many matches that were outside of his or her geographical range—say, 25 miles away—the system may assume distance wasn't a deal-breaker and may next offer more matches that were just a bit farther away.

More modest size systems may include core architecture of its system consisting of three to six front-end Web servers, for example, and a back-end SQL Server database, plus a variety of servers that handle messaging, marketing and other functions. In another example, a site may use about 200 servers, including a 64-bit, 32-processor Unisys server running Microsoft SQL Server, for example. The matching algorithm's calculations can be performed on an array of 64-bit servers that hold a compressed version of the entire multi-terabyte database in memory to facilitate fast matching.

Toward the other end of the spectrum, the systems may be more simple, focusing on searching and filters, for example, and employing relatively shorter questionnaires, and possible avoiding complex matching algorithms. Such a business may operate, for example, on approximately two to four Web servers, four to six messaging servers, four to six database servers (e.g., the database is about 100 GB to 300 GB in size), yet it may serve billions of pages a month to some millions of users. In this less intense example, operating cost may only be a few hundred thousand dollars a year. In certain examples, the largest piece may not be the onsite technology, but the bandwidth for keeping traffic to the site flowing smoothly.

Moreover, online dating sites may offer different tech-driven options for contacting and getting to know prospective dates, everything from chat rooms to instant messaging, email and/or single point-to-point video chat. In contrast to existing art, the present techniques provide for multiple live streaming video capabilities to allow an individual to include numerous friends/associates to interact/collaborate with him/her and his/her date or other friends all simultaneously in the same dating/audition or virtual social session. It is believed no existing online dating or virtual social networking services currently offers such an advanced capability for consumers. In addition, the present techniques may offer a mobile phone application which facilitates consumers to communicate with their contacts via live streaming video.

Video and/or web conferencing may be beneficial in the internet dating industry. It is used to conduct live meetings or presentations via the internet. In such conferences, each participant sits at his or her own computer and is connected to other participants via the internet. This can be either a downloaded application on each of the participants' computers or a web-based application where the participant will simply enter a URL (website address), for example, in order to enter the conference. Web conferencing typically is conducted in a one-way fashion, from the speaker to the audience with limited audience interaction, such as in a webcast. It can be collaborative and include polling and question & answer sessions to allow full participation between the audience and the presenter. In some cases, the presenter may speak over a standard telephone line, pointing out information being presented on screen and the audience can respond over their own telephones, preferably a speaker phone. There are web conferencing technologies on the market that have incorporated the use of VoIP audio technology, to allow for a truly web-based communication. Webinars may (depending upon the provider) provide hidden or anonymous participant functionality, enabling participants to be unaware of other participants in the same meeting. In the early years of the internet, the terms “web conferencing” was often used to describe a group discussion in a message board and therefore not live. The term has evolved to refer specifically to live or “synchronous” meetings. It is essentially available to users with an internet connection. Thus, people are typically able to join conferences from various computers, networks, and geographical locations

It essentially provides for a group of individuals around the world who have internet access to be able to hold a simultaneous meeting together without having to physically meet one another in any specific location via live streaming video. It's an approach of combining simultaneous video and audio so that a meaningful discussion or meeting can take place in real-time over the internet. The equipment to participate in a video conference may include: a video camera (also called a webcam), a microphone, video conferencing software, and the computer equipment to connect to the internet and process the sound and video data.

To accomplish the transmission of the video and audio portions of the meeting, the video conferencing software employed may take the input from the microphones and cameras, convert them into digital signals that are encoded, and then transmitted across the internet where they are received and decoded back into images and sound on the other end. This communications technology may facilitate people with needs to meet with a group of other people who may not be local to them. There are many other ways to make good use of internet video conferencing, as they can be beneficial for groups of people to meet and discuss topics in real-time without physically gathering together in the same place.

The present techniques may take advantage of a unique combination of aspects of the aforementioned described systems, services, and approaches. In contrast, separate membership with the previously-described services/sites (e.g., virtual social networking, online dating, etc.) may create frustrations and reduce efficiency in terms of time and/or money associated with each separate membership. An approach and an objective of the present techniques may be to reduce this discomfort and limitation, and offer a single “hub” or site (or only two or three hubs or sites) through which users, irrespective of their geographical locations, are able to access and interact via live multi-point streaming video/audio with friends, family members, associates, dates and share countless data and information as they are with each independent and separate sites.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A computer-implemented method for facilitating selection of a dating partner that allows for human filtering via live multi-point streaming videos/audios and/or via live chat in a chat room which provides a more meaningful innovative process for helping one to select the right potential candidate to socialize with or date, comprising:
selecting a plurality of candidate dating partners from a database;
creating a list of the candidate dating partners, the list including the selected candidate dating partners;
forming a panel; and
evaluating each of the candidate dating partners in the list of candidate dating partners;
wherein the evaluation is interactively performed by a host and the panel substantially in real time.

2. The computer-implemented method of claim 1, wherein associated with each candidate dating partner on the list is a video, and the evaluation includes selecting the video, the selected video viewable together by the host and the panel.

3. The computer-implemented method of claim 2, wherein the hosts and panelists can view each other on a screen in real time during the evaluation.

3. The computer-implemented method of claim 1, wherein the panel includes a plurality of online acquaintances of the host.

4. The computer-implemented method of claim 3, wherein the each of the panelists was invited to be on the panel by the host.

5. The computer-implemented method of claim 1, further comprising:
selecting a candidate dating partner from the list of candidate dating partners; and
inviting the selected partner to an online audition.

6. The computer-implemented method of claim 1, further comprising:
inviting a host for the online audition;
displaying real time videos of the selected candidate dating partner and the invited host on a screen; and
providing access to the online audition to a panel.

7. The computer-implemented method of claim 6, wherein the invited host for the online audition is different from the person hosting the evaluation.

8. The computer-implemented method of claim 6, wherein the access to the online audition to the panel includes allowing each panelist on the panel to view the host, the selected candidate dating partner and the other panelists.

9. The computer-implemented method of claim 8, wherein the selected candidate dating partner cannot view the panel.

10. The computer-implemented method of claim 6, wherein panelists on the panel can interact with the other panelists and the host using a chat box.

11. The computer-implemented method of claim 10, wherein the chat box is not viewable by the selected candidate dating partner.

12. The computer-implemented method of claim 1, further comprising:
selecting a candidate dating partner from the list of candidate dating partners;
inviting the candidate dating partner on a speed date;
performing the speed date by:
for a predetermined amount of time,
displaying videos of the selected candidate and a host on a screen, the videos including substantially real time live video images; and
allowing a panel to observe the speed date.

13. The computer-implemented method of claim 12, further comprising allowing the panel to comment on the speed date.

14. The computer-implemented method of claim 13, wherein comments by the panelists in the panel are provided in a chat box.

15. A computer-implemented method for facilitating selection of a candidate, comprising:
selecting a plurality of candidates from a database;
creating a list of the candidates, the list including the selected candidates;
forming a panel; and
evaluating each of the candidates in the list of candidates;
wherein the evaluation is interactively performed by a host and the panel substantially in real time.

16. The computer-implemented method of claim 15, wherein the host and members of the panel can view each other on a screen in real time during the evaluation.

17. The computer-implemented method of claim 6, further including the step of forming a second panel, the second panel formed by the selected candidate dating partner.

18. The computer-implemented method of claim 12, further including the step of forming a second panel, the second panel formed by the selected candidate dating partner.
